(19) United States
(12) Patent Application Publication
(10) Pub. No.: US 2025/0291636 A1
(43) Pub. Date: Sep. 18, 2025

(54) MULTI-CLUSTER RESOURCE ALLOCATION FOR DISTRIBUTED APPLICATIONS

(71) Applicant: HSBC GLOBAL SERVICES (UK) LIMITED, London (GB)

(72) Inventors: John TRAVERS, London (GB); Simon MILLS, London (GB); Damian ROWE, London (GB); Stefan STOYCHEV, London (GB); Howard TEALL, London (GB); Jason MICHAELIDES, London (GB)

(21) Appl. No.: 19/223,222

(22) Filed: May 30, 2025

(51) Int. Cl. G06F 9/50; H04L 9/40; H04L 67/10

(52) U.S. Cl. CPC G06F 9/5027; H04L 63/104; H04L 67/10; G06F 2209/505

(57) ABSTRACT

This disclosure provides systems, methods, and devices that efficiently assign users to shared instances of a distributed application based on data access requirements and distribute these instances across multiple servers. In one aspect, a method is provided that includes determining data access requirements for a plurality of users; assigning each user to one of a plurality of groups based on similar requirements; assigning a plurality of application instances, each corresponding to a group, to a plurality of servers, where each instance provides access to data relevant to its group; and executing the instances on the servers. Assigning users may involve selecting an initial user with the largest requirement, then iteratively adding users who cause the smallest incremental increase in the group's required data size until a condition is met.

### BACKGROUND

Modern computing environments frequently involve distributed applications designed to provide services, analytics, or other functionalities to a large number of users. These applications often need to process and manage substantial volumes of data, which may be sourced from various enterprise systems. Examples include business intelligence (BI) platforms, customer relationship management (CRM) systems, financial analytics tools, and other data-intensive applications.

To handle the processing load and provide adequate performance, these distributed applications are typically hosted on server infrastructure, which may consist of multiple physical or virtual servers. These servers can be organized into clusters, where groups of servers work together, potentially sharing resources and being managed collectively. Such architectures allow for scalability and resilience, enabling organizations to support growing user bases and data volumes while maintaining service availability. Providing users with efficient and timely access to the specific data they require within these complex environments is a common objective.

### SUMMARY

The present techniques relate to systems and methods for managing and scaling distributed applications, particularly those dealing with large datasets and numerous users with varying data access requirements. The techniques may involve determining data access requirements for each user and assigning users into groups based on the similarity of these requirements, often using an iterative process that aims to minimize the incremental data size increase when adding users to a group until a predefined condition, such as a data size threshold, is met. Corresponding instances of the distributed application, each potentially including a tailored data store (e.g., an in-memory hypercube), may be created for each user group. These instances may then be assigned to a plurality of servers, potentially spanning multiple server clusters, using an assignment pattern (e.g., a zigzag pattern based on instance size) designed to balance resource utilization across the servers. A mapping may be maintained to track user-to-instance and instance-to-server assignments. A first application, such as a landing page, may receive user requests, consult the mapping, and route the user's computing device to the correct assigned instance on the appropriate server, potentially passing authentication credentials to facilitate a seamless experience. These assignments may be performed periodically to adapt to changing requirements and system conditions.

In a first aspect, a method is provided that includes determining, by a computing system, data access requirements for each user of a plurality of users; assigning each user to one of a plurality of groups, wherein each group includes users with the same or similar data access requirements; assigning a plurality of instances of a distributed application to a plurality of servers, wherein each instance of the distributed application corresponds to a respective group of the plurality of groups and provides access to data corresponding to the data access requirements of the users in the respective group; and executing the plurality of instances of the distributed application by the plurality of servers.

In a second aspect according to the first aspect, assigning each user to one of the groups includes selecting an initial user with the largest data access requirement, and iteratively adding additional users to the group by, for each remaining user not yet assigned to a group, determining a data overlap metric between the data access requirements of the remaining user and the users already in the group, calculating an incremental increase in data size that would result from adding the remaining user to the group, selecting the remaining user whose addition results in the smallest increase in total data size of the group's data requirements, adding the selected user to the group, and continuing to iteratively add additional users to the group until a predefined condition is satisfied.

In a third aspect according to the second aspect, the predefined condition is satisfying at least one of: a maximum data size threshold for the group's data requirements, a maximum number of users assigned to the group, or a maximum total number of groups formed.

In a fourth aspect according to any one of the first through third aspects, each instance of the distributed application includes a data store comprising the data corresponding to the data access requirements of the users in the respective group, and the method further includes initializing the data store based on the combined data access requirements of the users in the respective group.

In a fifth aspect according to the fourth aspect, initializing the data store includes loading into the data store the data corresponding to the combined data access requirements of the users in the group, and configuring the data store to enable querying and analysis of the loaded data by the users in the group.

In a sixth aspect according to the fourth aspect, the data store is implemented as a hypercube in a Qlik application.

In a seventh aspect according to any one of the first through sixth aspects, the method further includes periodically reassigning users to the plurality of groups, periodically reassigning the plurality of instances of the distributed application to the plurality of servers, or a combination thereof, based on changes in user data access requirements, changes in data volumes, or a combination thereof.

In an eighth aspect according to any one of the first through seventh aspects, the plurality of servers are organized into a plurality of clusters, and assigning the plurality of instances includes assigning instances to servers located in at least two different clusters of the plurality of clusters.

In a ninth aspect according to any one of the first through eighth aspects, assigning the instances to the plurality of servers further includes determining a size metric for each instance based on the data requirements of the corresponding group; sorting the instances based on the determined size metrics; and iteratively assigning the sorted instances to the plurality of servers by selecting an instance based on the sorted order, selecting a target server according to an assignment pattern, and assigning the selected instance to the target server.

In a tenth aspect according to the ninth aspect, selecting the target server according to the assignment pattern includes assigning instances to servers in a first sequence for a first pass through the sorted instances, and assigning instances to servers in a sequence that is the reverse of the first sequence for a subsequent pass through the sorted instances.

In an eleventh aspect according to any one of the first through tenth aspects, the method further includes determining, after assigning the plurality of instances to the plurality of servers, a mapping of user identifiers to their assigned instances of the distributed application and corresponding server assignments.

In a twelfth aspect according to the eleventh aspect, the method further includes receiving, at a first application, a request from a user computing device; determining, based on the mapping, an assigned instance of the distributed application and a corresponding server for the user associated with the request; and routing, by the first application, the user computing device to the assigned instance on the corresponding server.

In a thirteenth aspect according to the twelfth aspect, the first application is a landing page application configured to route user requests.

In a fourteenth aspect according to the twelfth or thirteenth aspect, routing the user computing device includes determining a URL based on the mapping of the user's identifier to the assigned instance and server, and directing the user computing device to the determined URL.

In a fifteenth aspect according to any one of the twelfth through fourteenth aspects, routing the user computing device further includes transmitting authentication credentials or tokens associated with the user to the assigned instance of the distributed application.

In a sixteenth aspect according to any one of the first through fifteenth aspects, the method further includes preloading the instances of the distributed application into memory of the assigned servers, and maintaining the instances in memory by performing periodic interactions to prevent unloading due to inactivity.

In a seventeenth aspect, a system includes a processor and a memory storing instructions which, when executed by the processor, cause the processor to perform operations including determining data access requirements for each user of a plurality of users; assigning each user to one of a plurality of groups, wherein each group includes users with the same or similar data access requirements; assigning a plurality of instances of a distributed application to a plurality of servers, wherein each instance of the distributed application corresponds to a respective group of the plurality of groups and provides access to data corresponding to the data access requirements of the users in the respective group; and controlling the plurality of servers to execute the plurality of instances of the distributed application.

In an eighteenth aspect according to the seventeenth aspect, assigning each user to one of the groups includes selecting an initial user with the largest data access requirement, iteratively adding additional users to the group by, for each remaining user not yet assigned to a group, determining a data overlap metric between the data access requirements of the remaining user and the users already in the group, calculating an incremental increase in data size that would result from adding the remaining user to the group, selecting the remaining user whose addition results in the smallest increase in total data size of the group's data requirements, adding the selected user to the group, and continuing to iteratively add additional users to the group until a predefined condition is satisfied.

In a nineteenth aspect according to any one of the seventeenth through eighteenth aspects, the plurality of servers are organized into a plurality of clusters, and assigning the plurality of instances includes assigning instances to servers located in at least two different clusters of the plurality of clusters.

In a twentieth aspect, a non-transitory, computer-readable medium stores instructions which, when executed by a processor, cause the processor to perform operations including determining data access requirements for each user of a plurality of users; assigning each user to one of a plurality of groups, wherein each group includes users with the same or similar data access requirements; assigning a plurality of instances of a distributed application to a plurality of servers, wherein each instance of the distributed application corresponds to a respective group of the plurality of groups and provides access to data corresponding to the data access requirements of the users in the respective group; and controlling the plurality of servers to execute the plurality of instances of the distributed application.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a system for distributed application assignment and balancing according to one aspect of the present disclosure.

FIG. 2 illustrates a flowchart for a method for grouping users of a distributed application according to one aspect of the present disclosure.

FIG. 3 illustrates a flowchart for a method for assigning application instances to servers according to one aspect of the present disclosure.

FIG. 4 illustrates a mapping according to one aspect of the present disclosure.

FIG. 5 illustrates a sequence diagram for a user request routing procedure according to one aspect of the present disclosure.

FIG. 6 illustrates a block diagram of a system according to one aspect of the present disclosure.

FIG. 7 depicts a method for distributed application assignment and balancing according to one aspect of the present disclosure.

FIG. 8 depicts a computer system 800 according to one aspect of the present disclosure.

### DETAILED DESCRIPTION OF EXAMPLE EMBODIMENTS

Existing techniques for deploying distributed applications, particularly analytics platforms serving many users with distinct data access needs, often face challenges related to scalability and performance. One common approach involves creating a single, monolithic instance of the application containing all data for all users. While simple to manage initially, this approach may lead to significant performance degradation as data volumes grow, resulting in slow response times and a poor user experience, because the single instance becomes too large to process queries efficiently within acceptable timeframes. Another approach involves creating separate, dedicated application instances for each individual user or small user segments. While this can offer better performance for each user (e.g., as their instance only contains relevant data), it often leads to excessive consumption of computing resources, particularly server memory, as numerous instances need to be loaded and maintained concurrently. This approach may become prohibitively expensive or infeasible due to hardware limitations.

Furthermore, many distributed application platforms have inherent limitations on the scalability of a single cluster. For example, a platform might impose a maximum number of servers that can operate within one managed cluster. Vertical scaling (using larger, more powerful servers) may also have practical limits based on available hardware or cost constraints. When the demands of the application exceed the capacity of a single cluster (either due to the number of users, the volume of data, or the number of required instances), organizations may deploy additional, independent clusters. However, without an integrated approach, this often forces users to connect to different entry points (e.g., different URLs) depending on which cluster hosts their specific data or application instance, creating a fragmented and confusing user experience. Managing data partitioning and entitlements efficiently across potentially thousands of users whose access rights change frequently adds another layer of complexity to these traditional deployment models.

One solution to this problem is to combine intelligent user grouping with a multi-cluster architecture and seamless routing. The described techniques may first determine the specific data access requirements for each user. Based on these requirements, users may be assigned to groups where members have similar or overlapping data needs. This assignment may use an iterative algorithm that starts new groups with users having large data requirements and adds subsequent users by selecting those who cause the smallest incremental increase to the group's combined data footprint, continuing until a predefined size threshold (e.g., determined based on performance testing) is met. This grouping strategy directly addresses the performance/resource trade-off by creating shared application instances and data stores that are large enough to achieve resource efficiency (compared to individual instances) but small enough to maintain good performance (e.g., compared to a single monolithic instance).

Corresponding application instances, each tailored with a data store containing the data needed by its assigned group, may then be created. These instances may be assigned across a plurality of servers, potentially spanning multiple clusters, using a balancing assignment pattern (e.g., a zigzag pattern based on instance size) to distribute resource consumption evenly. This overcomes platform limitations on single-cluster size and enables horizontal scaling beyond those limits. To address the user experience challenge of multiple clusters, a central mapping linking users to their specific assigned instance and server location may be maintained. A first application (e.g., a landing page) acts as a single entry point. When a user connects, this application consults the mapping and automatically routes the user's device to the correct instance on the correct server in the correct cluster, potentially passing authentication credentials for a single sign-on experience. This routing mechanism hides the underlying multi-cluster complexity from the end-user, providing a unified and seamless access experience regardless of how the instances are distributed across the infrastructure.

In some aspects, the present disclosure provides techniques for assigning users and application instances across potentially multiple server clusters that may be particularly beneficial in large-scale distributed application environments, such as business intelligence or analytics platforms. For example, the described techniques may allow systems to scale horizontally beyond the inherent limitations of the underlying application platform (e.g., maximum servers per cluster), providing a path for continued growth in users and data volume without compromising performance or requiring platform replacement. By grouping users with similar data needs into shared application instances sized for optimal performance, the techniques may significantly reduce resource consumption (particularly server memory) compared to approaches requiring individual instances per user, potentially leading to substantial cost savings and more efficient hardware utilization. The instance assignment patterns, such as the zigzag method, may further enhance efficiency by balancing the load across available servers, preventing bottlenecks and potentially improving overall system throughput.

From an end-user perspective, the combination of optimized instance sizing and the seamless routing mechanism may result in a consistently responsive experience, even with very large datasets, as users interact with data stores tailored to their group's needs. The use of a single entry point (e.g., the landing page application) that automatically directs users to the correct backend instance, regardless of its location across potentially multiple clusters, provides a unified and simplified user experience, eliminating the need for users to manage multiple URLs or be aware of the underlying infrastructure complexity. Furthermore, the techniques may improve the functioning of the computer system itself by enabling more efficient use of server memory through balanced loading and optimized data store sizing, potentially improving cache effectiveness within the application instances, and reducing the computational overhead associated with managing excessively large or numerous individual application instances. The automated routing also improves computer function by efficiently directing network traffic without requiring complex client-side configuration or user intervention.

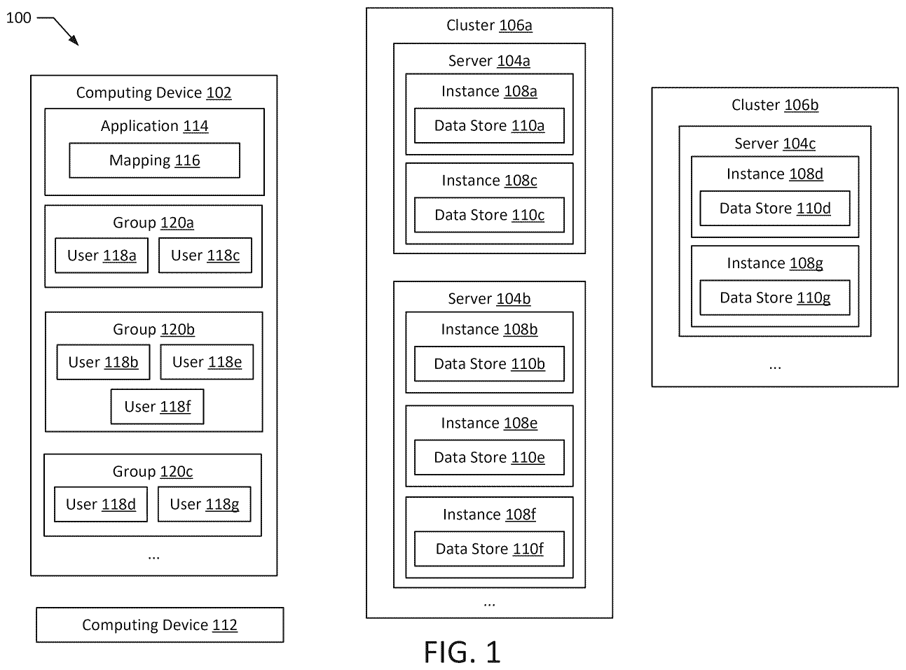

FIG. 1 illustrates a system 100 for distributed application assignment and balancing according to one aspect of the present disclosure. The system 100 includes a computing system 102, a plurality of servers 104a, 104b, 104c (collectively referred to as “servers 104”) organized into one or more clusters 106a, 106b (collectively referred to as “clusters 106”), a plurality of instances 108a, 108b, 108c, 108e, 108f, 108g, 108h (collectively referred to as “instances 108”) of a distributed application each including a data store 110a, 110b, 110c, 110e, 110f, 110g, 110h (collectively referred to as “data stores 110”), a user computing device 112, a first application 114 (which may function as a landing page application), and a mapping 116. The computing system 102 may interact with a plurality of users 118a, 118b, 118c, 118d, 118e, 118f, 118g (collectively referred to as “users 118”) and assign them to groups 120a, 120b, 120c (collectively referred to as “groups 120”).

The computing system 102 may be configured to determine data access requirements for each user 118 of a plurality of users. In certain implementations, the computing system 102 may include one or more physical servers, potentially organized into a cluster of servers 106, or may be implemented within a cloud-based computing environment utilizing virtualized resources. For example, the computing system 102 may be configured to leverage dedicated processing servers within a separate cluster specifically allocated for determining data access requirements and performing user and instance assignment tasks.

Data access requirements may refer to the specific set of data that a particular user 118 is authorized to view, analyze, or interact with within the context of the distributed application. In certain implementations, these requirements may be represented as a list of data entities, such as specific companies within a portfolio, product lines, or geographical regions. Alternatively, data access requirements may be defined by specific rows or columns within underlying database tables, or through permissions derived from user roles, group memberships, or other attributes defined within an identity and access management system. For example, a specific user 118a might have requirements defined by their entitlement to view financial metrics for a specific list of client companies, while another user 118b might have requirements defined by access to aggregated data for a particular business unit.

Different types of users within an organization may typically exhibit distinct patterns of data access requirements when interacting with a distributed application instance 108. For instance, in a financial analytics application, an individual relationship manager (e.g., representing a user 118a) might require detailed access to all financial metrics related to a specific portfolio of 50-100 client companies. In contrast, a regional manager (e.g., representing another user 118d) might need access to aggregated performance metrics across all relationship managers and client companies within their designated region, potentially covering thousands of companies but perhaps only summary-level data for each. A senior executive might require access to top-level, aggregated metrics across the entire organization.

The computing system 102 may be configured to determine the data access requirements using various techniques. In certain implementations, determining the requirements may involve querying an authoritative entitlement database or system that stores user permissions. This entitlement system might map user identifiers to specific data entities or attributes. For instance, the computing system 102 could query an entitlements table that lists, for each user 118, the specific set of companies or accounts they manage. In other implementations, determining requirements might involve parsing user profile information, analyzing historical user activity logs to infer data needs, or interfacing with external systems managing roles and permissions. The data sources used for determining requirements may include dedicated entitlement databases, Active Directory groups, Human Resources systems defining user roles and hierarchies, or specific configuration files mapping users to data segments.

The size or scope of a user's data access requirements may be measured or quantified using various metrics to facilitate subsequent grouping and resource allocation steps. In certain implementations, data access requirements may be quantified by the number of rows in a primary fact table that a user 118 is authorized to access, based on their entitlements. For example, if the core data involves financial transactions (the fact table), the size metric for a user 118a might be the total count of transaction rows associated with the companies in that user's portfolio. Other potential metrics could include the total data volume (e.g., in gigabytes) required by the user, the number of distinct entities (e.g., companies, products) the user can access, the computational complexity associated with generating the user's required views, and the like.

Data access requirements for users 118 may vary over time and possess different levels of granularity. For example, user entitlements across an organization may change frequently, potentially on a daily basis, as users change roles, gain new responsibilities, or have their portfolios adjusted. This may necessitate periodic redetermination of requirements. Furthermore, requirements might exist at different levels of detail; one user 118a might need access to granular, row-level transaction data, while another user 118b might only require access to higher-level aggregated summaries across multiple dimensions. The computing system 102 may be configured to accommodate these variations when determining requirements. For instance, the system 102 might determine that one user 118a requires access to individual transaction records (e.g., data with a high granularity) for their assigned clients, while another user 118b requires only monthly summary totals (e.g., data with a lower granularity) for the same set of clients, and the system 102 would quantify these distinct requirements accordingly.

The computing device 102 may be configured to assign each user 118 to one of a plurality of groups 120, wherein each group 120 includes users 118 with the same or similar determined data access requirements. A group 120, in this context, may refer to a logical collection of users 118 established by the computing system 102. The purpose of forming these groups 120 may be to consolidate users 118 who need access to largely overlapping sets of data, thereby enabling them to share a single instance 108 of the distributed application and its associated data store 110, rather than requiring individual instances for each user 118.

Same or similar data access requirements may refer to the degree of commonality between the specific data sets required by different users 118. The computing system 102 may use various criteria or metrics to quantify this similarity. For instance, similarity may be measured by the percentage of data entities (e.g., companies, accounts, records) that overlap between the requirements of two users 118. A high percentage overlap might indicate high similarity. Other criteria could include the number or proportion of common data entities accessed, shared dimensions required for analysis, or similarity in user roles or positions within an organizational hierarchy. For example, two users 118a, 118c might be considered to have similar requirements if 90% or more of the specific data records they are entitled to access are identical.

In certain implementations, the computing system 102 may assign each user 118 to one of the groups 120 using an iterative approach. This approach may begin by selecting an initial user 118 having the largest data access requirement to seed a new group 120. The largest requirement may be measured using metrics such as the number of rows in a relevant fact table that the user 118 is entitled to access. For example, the computing system 102 might identify the user 118 whose entitlements grant access to the highest number of transaction records in the core dataset. Following the selection of this initial user 118, the computing system 102 may iteratively add additional users 118 to that group 120. This iterative addition process may involve evaluating remaining users 118 not yet assigned to any group 120. For each remaining user 118, the computing system 102 may determine a data overlap metric between the data access requirements of that remaining user 118 and the combined requirements of the users 118 already present in the current group 120. The data overlap metric may quantify the extent of shared data requirements. For instance, the data overlap metric may be determined as the Jaccard index applied to the sets of unique data record identifiers required by the remaining user 118 and the current group 120, or simply the count of shared primary keys or data entities. Additionally or alternatively, the computing system 102 may calculate an incremental increase in data size that would result from adding the remaining user 118 to the group 120. This incremental increase may represent the amount of new data (not already required by users 118 in the group 120) that would need to be added to the group's corresponding data store 110. For example, if the group 120a currently requires 10million specific data rows and a candidate user 118 requires 2 million rows, 1.5 million of which are already included in the group's 10 million rows, the incremental increase would correspond to the 0.5 million new rows. This determination may consider unique row counts, memory footprint estimates, or other relevant factors depending on the application's data structure. Based on the data overlap metrics for remaining users 118, the computing system 102 may select the user 118 whose addition to the group 120 results in the smallest incremental increase in the total data size required by the group 120. This selection criterion aims to maximize the density of data usage within the group 120. Once selected, the computing system 102 adds the chosen user 118 to the current group 120. The computing system 102 may continue this process of iteratively adding users 118 one by one to the current group 120 until a predefined condition is satisfied. Once the condition is met for a group 120, the computing system 102 may start a new group 120, again selecting the user 118 with the largest requirement from the pool of remaining, unassigned users 118, and repeating the iterative addition process until all users 118 are assigned to a group 120.

The predefined condition for stopping the addition of users 118 to a group 120 may involve satisfying at least one of several potential criteria. One criterion may be reaching a maximum data size threshold for the combined data access requirements of the group 120. This threshold represents the upper limit on the amount of data (e.g., measured in rows or gigabytes) that can be efficiently handled by a single application instance 108 while maintaining acceptable performance. For example, based on performance testing conducted for a specific hardware configuration (such as servers 104 with 256 GB RAM) and a specific data model, the maximum data size threshold might be determined to be 132 million rows in a core fact table. Reaching or exceeding such a determined threshold would satisfy the condition. Another potential criterion may be reaching a maximum number of users 118 assigned to the group 120. This limit might be imposed based on administrative considerations or potential contention for resources within the shared instance 108. Additional or alternative implementations may consider criteria such as reaching a maximum total number of groups 120 formed, which might be dictated by the available number of servers 104 or licensed instances 108. In certain implementations, one or more conditions may be combined. For example, the process of adding users 118 to a group 120 might stop if either the data size threshold or the maximum user count is reached.

While the iterative technique described above represents one implementation, the computing system 102 may employ alternative techniques or strategies for assigning users 118 to groups 120. For example, other clustering techniques (e.g., k-means based on data requirement vectors, hierarchical clustering) may be utilized to determine the groups 120.

As one particular example, the computing system 102 might determine that user 118a requires access to data related to entities {X, Y, Z}, user 118b requires access to entities {P, Q, R, S}, and user 118c requires access primarily to entities {X, Y}, making user 118c's requirements highly similar to a subset of user 118a's requirements. Assuming user 118a has the largest requirement, the user 118a may be initially selected for group 120a. User 118c, having high overlap ({X, Y}) may be iteratively added to group 120a. Similarly, user 118b may be initially selected for group 120b, and users 118e and 118f, having significant overlap with user 118b or each other, might be added iteratively until a condition (e.g., data size threshold) is met. User 118d might seed group 120c, potentially joined by user 118g. This results in the illustrated groups 120a, 120b, 120c, each containing corresponding subsets of the users 118.

The computing device 102 may be configured to assign a plurality of instances 108 of a distributed application to a plurality of servers 104. Each instance 108 of the distributed application corresponds to a respective group 120 of the plurality of groups 120 and provides access to data corresponding to the data access requirements of the users 118 in the respective group 120. An instance 108 of a distributed application may refer to a specific, executing copy of the application software, tailored to serve a particular group 120 of users 118. In certain implementations, such an instance 108 may represent an analytics application, like a Qlik Sense application instance or a specific business intelligence dashboard instance. In certain implementations, an instance 108 may include both the application logic (e.g., calculations, visualizations, user interface elements) and the relevant data required by the assigned group 120.

In certain implementations, there may be a one-to-one mapping between each group 120 and a corresponding instance 108 created and assigned in this step. That is, for every group 120 (e.g., 120a), there may be a dedicated instance 108 (e.g., 108a). An instance 108 may provide access to data by making the data relevant to a corresponding group 120 available for querying, analysis, and visualization by the users 118 within that group 120. In certain implementations, this involves the instance 108 loading the necessary data subset into a corresponding memory space or a closely associated data structure upon initialization or execution of the instance 108. For example, an analytics application instance 108 might load its required data subset from underlying databases or data warehouses into an in-memory data store 110 for rapid processing and response to user interactions.

In certain implementations, each instance 108 of the distributed application includes a data store 110 that includes the data corresponding to the data access requirements of the users 118 in the respective group 120. The computing system 102 may be further configured to initialize the data store 110 based on the combined data access requirements of the users 118 in the respective group 120. A data store 110 may refer to a dedicated data structure or storage mechanism managed by or associated with a specific application instance 108. The data store 110 may typically include a copy of the relevant subset of data needed by the users 118 in the corresponding group 120. This data store 110 may contain only the data required by its group 120, as opposed to the entire dataset available within the larger system 100. The initialization process for a data store 110 may involve several operations, potentially including data extraction from source systems, transformation of the data into a suitable format, and loading (e.g., ETL) the processed data into the data store 110 structure. Data sources may include relational databases, data warehouses, flat files, or other enterprise data repositories. The combined data requirements used for initialization may be determined by taking the logical union of the data access requirements of all individual users 118 assigned to the corresponding group 120. For example, if user 118a needs access to data for companies A, B, C and user 118c needs access to data for companies B, C, D, the combined requirement for their group 120a would cover companies A, B, C, and D, and the data store 110a would be initialized with data for these four companies.

Initializing the data store 110 may specifically involve loading into the data store 110 the data corresponding to the combined data access requirements of the users 118 in the group 120, and configuring the data store 110 to enable querying and analysis of the loaded data by the users 118 in the group 120. The data loading process may utilize particular data integration tools, scripts, built-in functionalities of the distributed application platform, and the like. Loading might occur periodically (e.g., nightly) or on-demand when the instance 108 is first created or assigned. The configuration step may involve setting various parameters or settings within the data store 110 or the associated application instance 108. This configuration might include defining the data model (relationships between tables or entities), building necessary indexes to accelerate queries, setting up pre-calculated aggregations, or initializing specific calculation engines used by the application instance 108. These configuration actions may prepare the data store 110 to efficiently respond to user queries and analytical operations.

In certain exemplary implementations, the data store 110 may be implemented as a hypercube within a Qlik application environment. A Qlik hypercube may include an in-memory data structure representing a multi-dimensional dataset, utilizing an associative model where relationships between data values are maintained. In this context, initializing the data store 110 may include creating and populating such a hypercube. For example, the computing system 102 might execute a Qlik load script. This script would connect to relevant data sources, extract data corresponding to the combined requirements of the users 118 in group 120a (e.g., filtering fact tables based on the union of company lists for users 118a, 118c), perform necessary transformations (e.g., joining tables, calculating new fields), and load the resulting data model into memory as the hypercube data store 110a for instance 108a. The configuration may define dimensions, measures, and default states within the Qlik application instance 108a that uses this hypercube 110a, enabling users 118a, 118c to perform interactive filtering, selections, and analysis through the Qlik application's interface.

In scenarios involving a large number of instances 108 or significant resource requirements, the plurality of servers 104 may be organized into a plurality of clusters 106. In such cases, assigning the plurality of instances 108 may involve assigning instances 108 to servers 104 located in at least two different clusters 106 (e.g., assigning instance 108a to server 104a in cluster 106a, and instance 108e to server 104c in cluster 106b). A cluster 106 may refer to a group of servers 104, which may be networked together and managed as a single unit and may include shared resources. The cluster 106 may also include a central management node coordinating tasks among member servers (sometimes referred to as rim nodes). For example, certain platforms might organize clusters 106 with one central node and up to eleven rim nodes available for hosting application instances 108. In certain implementations, multiple clusters 106 may be used overcome limitations inherent in a single cluster, such as platform-imposed maximums on the number of servers 104 per cluster (e.g., a 12-server limit). Utilizing multiple clusters 106 may thus provide enhanced scalability, allowing the system 100 to accommodate a growing number of users 118, increasing data volumes, and a larger number of required application instances 108. Multiple clusters 106 can also improve fault tolerance. The computing system 102 may determine the need for multiple clusters 106 when the total number of required instances 108 exceeds the capacity of a single cluster 106, based on the number of available servers 104 per cluster and the number of instances 108 that can be hosted per server 104. When multiple clusters 106 are used, the computing system 102 may employ a master assignment process that distributes instances 108 across all available servers 104 in all configured clusters 106.

Assigning the instances 108 to the plurality of servers 104 may further involve several operations to optimize resource allocation. The computing system 102 may first determine a size metric for each instance 108, which may be based on the data requirements (e.g., the size of the data store 110) of the corresponding group 120. This size metric could be the estimated memory footprint of the instance's data store 110, the number of rows in the primary data table within the data store 110, or another measure indicative of resource consumption. The computing system 102 may then sort the instances 108 based on these determined size metrics, for example, in descending order from largest to smallest. Subsequently, the computing system 102 may iteratively assign the sorted instances 108 to the plurality of available servers 104. This iterative assignment may involve selecting an instance 108 based on the sorted order (e.g., starting with the largest) and selecting a target server 104 according to a defined assignment pattern. An assignment pattern may refer to a specific technique or rule set used to choose the next server 104 for placement. Once the target server 104 is selected, the computing system 102 may then assign the selected instance 108 to that target server 104.

In certain implementations, the selection of the target server 104 according to the assignment pattern aims to balance resource utilization across the servers 104. One specific pattern involves assigning instances 108 to servers 104 in a first sequence during a first pass through the sorted list of instances 108, and then assigning instances 108 to servers 104 in a sequence that is the reverse of the first sequence for a subsequent pass through the sorted instances 108. For example, consider servers S1 (104a), S2 (104b), . . . , Sn. The first pass assigns the largest instance to S1, the second largest to S2, . . . , the nth largest to Sn. The subsequent pass assigns the (n+1)th largest instance to Sn, the (n+2)th largest to Sn-1, . . . , the (2n)th largest to S1. This alternating or zigzag assignment continues for further passes. Such an assignment pattern may distribute the load required to execute assigned instances more evenly by pairing larger instances (assigned in early passes in one direction) with smaller instances (assigned in later passes in the opposite direction) on the same servers 104, thus attempting to balance the total resource demand on each server 104. Other assignment patterns could also be used in various implementations, such as round-robin assignment or assigning the next instance 108 to the currently least-loaded server 104 based on estimated resource consumption.

Additional considerations may influence the assignment of instances 108 to servers 104. These might include the specific capacity of each server 104 (available RAM, CPU cores), network latency between servers 104 or between servers 104 and data sources, the current processing load on each server 104, or predefined affinity or anti-affinity rules (e.g., ensuring certain critical instances 108 run on separate hardware). The computing system 102 may maintain a resulting assignment mapping 116 to link each instance 108 (and implicitly, its corresponding group 120 and users 118) to a specific corresponding server 104 and, in certain implementations, a corresponding cluster 106. This mapping 116 may be stored in a database table or configuration file and is updated whenever the assignment process is run.

As one particular example, as illustrated in FIG. 1, after the groups 120 are formed, the corresponding instances 108 (e.g., 108a for group 120a, 108b for group 120b, 108c for group 120c) are assigned to servers 104 across clusters 106. The computing system 102 might determine size metrics for instances 108a, 108b, 108c, and other instances like 108e, 108f, 108g, 108h. If, for instance, 108b is the largest, 108a is second largest, and 108c is third largest, and servers 104a, 104b, 104c are available across clusters 106a, 106b, an assignment pattern might place 108b on server 104b, 108a on server 104a, and 108c also on server 104b (e.g., according to an assignment pattern). Subsequent, smaller instances like 108g, 108h, 108e, 108f may then be assigned according to the assignment pattern (e.g., an alternating pattern) to servers 104a, 104b, 104c to balance the load across the servers. As shown in FIG. 1, this may result in instances 108a and 108h assigned to server 104a in cluster 106a, instances 108b, 108c, and 108g assigned to server 104b in cluster 106a, and instances 108e and 108f assigned to server 104c in cluster 106b.

The plurality of instances 108 of the distributed application may then be executed by the plurality of servers 104 to which they were assigned. Executing an instance 108 may refer to the process by which a server 104 actively runs the application software associated with the instance 108. This typically entails loading the application instance 108 and its corresponding data store 110 (or portions thereof) into the server's 104 memory, initiating and running the necessary application processes, listening for and handling incoming requests from authorized users 118 associated with the instance's group 120, performing calculations based on user interactions or predefined logic, generating responses or updated views for the users 118, or combinations thereof.

In certain implementations, when particular platforms are utilized, such as Qlik, executing an instance 108 may involve loading the application (including its hypercube data store 110) into the memory (e.g., RAM) of the assigned server 104. A Qlik engine on the server 104 may then run the application instance 108, leveraging the in-memory data and associative model to rapidly respond to user selections and queries. When a user 118 interacts with the application instance 108 (e.g., makes a selection on a dashboard), the executing engine performs the necessary calculations on the fly using the in-memory data store 110, and may create temporary data structures or calculation results also held in memory, to update the user interface.

The interaction between an executing instance 108 and its users 118 typically occurs via user computing devices 112. A user 118, having been routed to the correct instance 108 on the correct server 104, interacts with the application's interface presented on their device 112. These interactions (e.g., clicking buttons, selecting filters, drilling down into data) may generate requests that are sent to the executing instance 108 on the server 104. The executing instance 108 processes these requests, performs calculations using its data store 110, and sends back updated data or visualizations to the user computing device 112 for display.

In certain implementations, the instances 108 of the distributed application may be preloaded into the memory of the assigned servers 104 and maintained in memory by performing periodic interactions to prevent unloading due to inactivity. The preloading process may involve proactively loading an instance 108 and its data store 110 into the server's 104 RAM before any user 118 attempts to access that specific instance 108. This preloading might occur shortly after the instances 108 are assigned to servers 104, or during scheduled off-peak hours, to prepare the system 100 for user activity. To maintain the instances 108 in active memory, especially on platforms that might automatically unload inactive applications to conserve resources, the computing system 102 or a related monitoring component may perform periodic interactions with each loaded instance 108. These interactions could take the form of keep-alive pings, simulated user selections, and/or lightweight dummy queries designed solely to signal activity to the hosting server 104 and application platform. The frequency of these interactions may be configured based on the platform's inactivity timeout settings (e.g., every 1 minute, every 5 minutes, every 30 minutes, every hour, and the like).

Executing instances 108, particularly those using in-memory data stores 110, may require significant memory management considerations for the servers 104. Each executing instance 108 consumes a certain amount of memory for its application code and its loaded data store 110. Additionally, available memory on the server 104 may be used by the application platform for caching intermediate calculation results or frequently accessed data subsets to further accelerate user interactions. Sufficient RAM must be available on each server 104 to accommodate all assigned instances 108 and allow adequate space for this caching activity. As the volume of data within data stores 110 potentially grows (e.g., over the course of a week as more historical data accumulates), the memory required by the instances 108 may increase, potentially reducing the memory available for caching on the server 104. The assignment process (balancing instance sizes across servers 104) attempts to mitigate uneven memory pressure.

Once users 118 have been assigned to groups 120, and the corresponding application instances 108 have been assigned to and executed by specific servers 104 across potentially multiple clusters 106, user requests may need to be received and directed to the correct instance 108 and server 104. In certain implementations, because the specific server 104 hosting the relevant instance 108 for a given user 118 may change periodically due to reassignment, and because the instances 108 are distributed across the infrastructure, users 118 cannot simply connect to a single, static endpoint. Therefore, the system 100 may utilize a central routing mechanism, such as a dedicated first application 114 and a mapping 116 that stores the current location of each user's assigned instance 108.

In particular, the computing device 102 (or another computing device of the system 100) may be configured to determine, after assigning the plurality of instances 108 to the plurality of servers 104, a mapping of user identifiers to their assigned instances 108 of the distributed application and corresponding server 104 assignments. This mapping effectively serves as a directory linking each user 118 to the specific application instance 108 and server 104 responsible for handling their requests. The structure of this mapping may take various forms, such as a database table, a key-value store, a flat file, or an in-memory data structure, maintained as the mapping 116. In certain implementations, the mapping 116 might include fields such as a unique User Identifier (e.g., Windows login ID), an Instance Identifier (e.g., a unique ID for the assigned application instance 108), a Server Identifier or Network Address (such as an identifier or address that indicates the specific server 104 hosting the instance 108), and potentially a Cluster Identifier (indicating the cluster 106 where the server 104 resides). This mapping is typically determined as an output of the user-to-group and instance-to-server assignment processes performed by the computing system 102. It may be updated whenever these assignment processes are executed, ensuring the mapping reflects the current state of instance 108 placement and user 118 allocation.

The computing device 102 may be configured to receive, at the first application 114, a request from a user computing device 112. Based on the determined mapping, the first application 114 may determine an assigned instance 108 of the distributed application and a corresponding server 104 for the user 118 associated with the request. Subsequently, the first application 114 may provide routing information to enable the user computing device 112 to connect to the assigned instance 108 on the corresponding server 104. The first application 114 may refer to a designated software component that acts as a central gateway or entry point for users 118 attempting to access the distributed application instances 108. Its primary role in this context may be to intercept initial user requests and provide the necessary information for the user computing device 112 to establish a connection with the appropriate instance 108 based on the maintained mapping 116. The process of receiving the request may involve the first application 114 receiving network traffic, such as an HTTP request or an API call, initiated by the user computing device 112. This initial request typically includes information identifying the user 118 (e.g., via authentication tokens or session cookies) and potentially indicating the desired target resource or application type. Upon receiving the request, the first application 114 may extract the user identifier and consult the mapping 116 to look up the specific instance 108 and server 104 assigned to that user 118. The routing mechanism employed by the first application 114 may involve providing the user computing device 112 with the necessary connection information (e.g., server address, instance identifier, and any required parameters) that enables an application running on the user computing device 112 (such as a React mashup application) to construct the appropriate URL and establish a direct connection to the determined target instance 108. Common methods include issuing an HTTP redirect response (e.g., status code 302) containing the address of the target instance 108 and server 104, or potentially acting as a reverse proxy that forwards the user's connection transparently.

In certain implementations, the first application 114 may be a landing page application configured specifically to handle user authentication and request routing. Such a landing page application 114 might be implemented as a web application, potentially using frameworks like React.js for the frontend user interface. The user interface of the landing page application 114 might be minimal, perhaps presenting a simple portal or immediately initiating the routing process after successful user authentication. This landing page application 114 may itself be hosted on one of the servers 104 within one of the available clusters 106; while its specific location might not be critical, it typically requires hosting within the same general infrastructure environment to access the mapping 116 and communicate with the distributed application instances 108.

The process of routing the user computing device 112 may involve determining, by the first application 114, a specific Uniform Resource Locator (URL) based on the mapping 116 of the user's identifier to the assigned instance 108 and server 104. The first application 114 may then direct the user computing device 112 to the determined URL. The structure of the determined URL may be designed to encode all necessary information for the user computing device 112 to connect to the correct resource. For example, the URL might include the network address (hostname or IP address) of the target server 104, a path or identifier specifying the assigned application instance 108 on that server 104, and potentially query parameters containing user context or session information. The first application 114 may direct the user's computing device 112 to this URL, such as by sending an HTTP redirect response containing the determined URL in a ‘Location’ header.

Furthermore, routing the user computing device 112 may include transmitting authentication credentials or tokens associated with the user 118 to the assigned instance 108 of the distributed application. These credentials or tokens may be industry-standard types such as Kerberos tickets, Security Assertion Markup Language (SAML) assertions, JSON Web Tokens (JWT), or other security tokens appropriate for the environment. The first application 114 might obtain these credentials during the initial user login process, or the credentials might be passed through from the user's initial request (e.g., in HTTP headers or cookies). In certain implementations, when the first application 114 and the target server 104 hosting the assigned instance 108 reside within the same cluster 106, the first application 114 may transmit these credentials or tokens directly to facilitate seamless authentication. In additional or alternative implementations, when the first application 114 and the target server 104 are located in different clusters 106, the transmission of credentials may be limited by cluster boundaries, and the application executing on the user computing device 112 (e.g., a React mashup application) may be configured to perform a separate authentication process to connect to the target cluster 106. The first application 114 may then include these credentials or tokens when routing the user 112 to the target instance 108. For example, the first application 114 may include the credentials or tokens in HTTP headers forwarded to the target server 104, embedding them within secure query parameters in the redirect URL, and/or utilizing a secure session transfer protocol between the first application 114 and the target instance 108. This credential transmission facilitates a seamless single sign-on (SSO) experience, allowing the user 118 to be automatically authenticated to the target application instance 108 without needing to log in again, even when being redirected across different servers 104 or clusters 106, such as when operating within the same cluster 106.

In certain implementations, the computing device 102 may be configured to periodically reassign users 118 to the plurality of groups 120, periodically reassigning the plurality of instances 108 to the plurality of servers 104, or a combination thereof, based on changes in user data access requirements, changes in data access volumes, or other system conditions. The trigger for such periodic reassignment could be a regularly scheduled task (e.g., running nightly, running weekly, running monthly, running quarterly, and the like) and/or the trigger may be event-driven, such as initiated upon detection of significant changes in user entitlements, substantial growth in data volumes, or observed imbalances in server 104 load. The reassignment process might involve re-executing the entire user-to-group assignment techniques and the instance-to-server assignment techniques discussed above, effectively rebuilding the assignments from scratch based on the latest data access requirements and system state. This periodic reassignment is often necessary because user entitlements can change frequently, as data volumes grow over time, and patterns of system usage may shift, rendering the previous assignments suboptimal. Rebuilding the assignments ensures that users 118 are grouped efficiently and that instances 108 are distributed across servers 104 in a balanced manner according to the most current information.

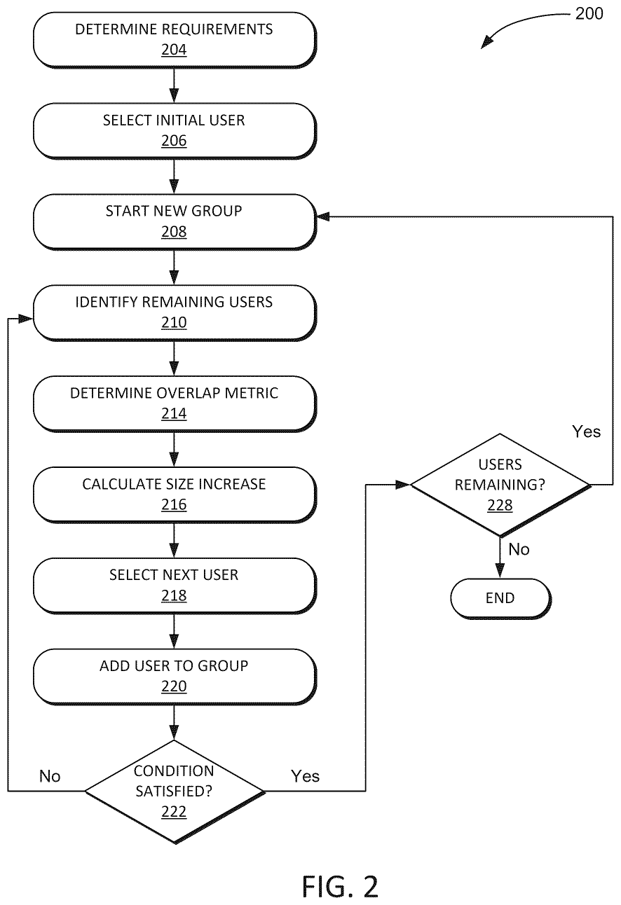

FIG. 2 illustrates a flowchart for a method 200 for grouping users of a distributed application according to one aspect of the present disclosure. The method 200 may be performed to assign users 118 to groups 120 based on their data access requirements. In certain implementations, the method 200 may be performed by the system 100 described in FIG. 1. For example, the computing device 102 may be configured to execute one or more operations of the method 200.

The method 200 may begin at block 204, where data access requirements may be determined for a plurality of users 118. In certain implementations, the computing device 102 may perform this determination by querying entitlement systems or analyzing user profiles, as previously described. Following the determination of requirements, the method 200 may proceed to block 206, where an initial user 118 may be selected. In certain implementations, the computing device 102 may select the user 118 identified as having the largest data access requirement, quantified using a metric such as the number of data rows needed.

Once the initial user 118 is selected, the method 200 may proceed to block 208, where a new group 120 is started with the selected initial user 118. The method 200 then enters an iterative process to potentially add more users 118 to the current group 120. At block 210, remaining users 118 who have not yet been assigned to any group 120 are identified. For these remaining users 118, the method 200 may proceed to blocks 214 and 216. At block 214, an overlap metric may be determined between each remaining user's 118 data access requirements and the combined requirements of the users 118 currently in the group 120 being formed. At block 216, the incremental increase in data size that would result from adding each remaining user 118 to the current group 120 may be calculated. For example, the computing device 102 may calculate these metrics based on shared data entities or row counts. Based on these calculations, at block 218, the next user 118 to add to the current group 120 may be selected. In certain implementations, the computing device 102 may select the user 118 whose addition causes the smallest incremental size increase, as determined in block 216. The selected user 118 may then be added to the current group 120 at block 220.

After adding a user 118 at block 220, the method 200 proceeds to decision block 222 to check if a predefined condition for the current group 120 has been satisfied. In certain implementations, this condition may relate to a maximum data size threshold (e.g., 132 million rows) or a maximum number of users 118 per group 120. If the condition is not satisfied (No path from 222), the method 200 returns to block 210 to identify the next set of remaining unassigned users 118 and potentially add another user 118 to the same current group 120 by repeating blocks 214 through 222. If the predefined condition is satisfied (Yes path from 222), the method 200 proceeds to decision block 228 to check if any users 118 remain unassigned across all groups 120. If unassigned users 118 do remain (Yes path from 228), the method 200 returns to block 208 to start a new group 120 with this newly selected initial user 118. This entire process may repeat multiple times, creating subsequent groups 120 until all users 118 are assigned. Once decision block 228 determines that no unassigned users 118 remain (No path from 228), the user grouping method 200 may conclude.

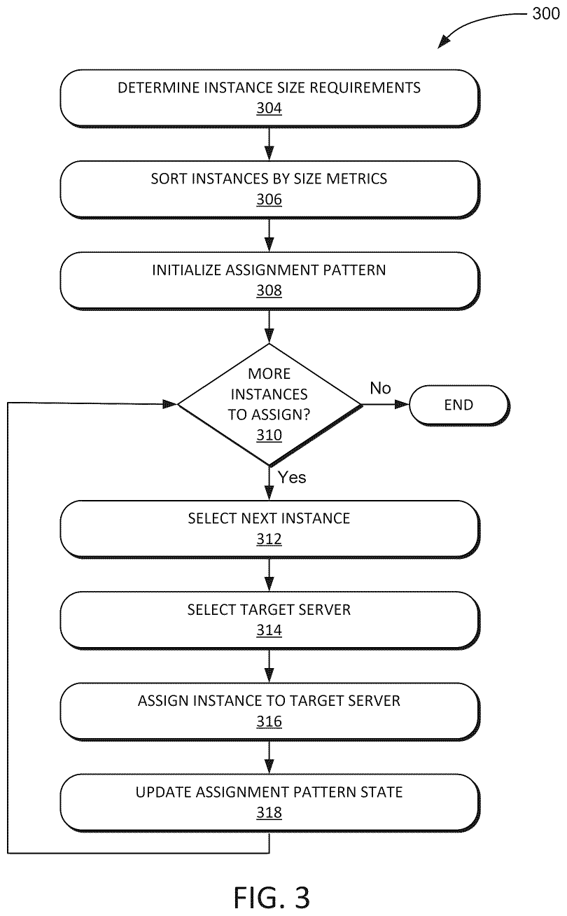

FIG. 3 illustrates a flowchart for a method 300 for assigning application instances to servers according to one aspect of the present disclosure. The method 300 may be performed to assign a plurality of instances 108 of a distributed application to a plurality of servers 104. In certain implementations, the method 300 may be performed by the system 100 described in FIG. 1. For example, the computing device 102 may be configured to execute one or more operations of the method 300, potentially after users 118 have been assigned to groups 120 and corresponding instances 108 have been identified.

The instance assignment method 300 may begin at block 304, where a size metric may be determined for each instance 108 that needs to be assigned. In certain implementations, the computing device 102 may determine this metric based on the data requirements of the corresponding group 120, such as the memory footprint of the instance's data store 110 or the number of rows in a primary data table within the data store 110. Following the determination of size metrics, the method 300 may proceed to block 306, where the instances 108 may be sorted based on the determined size metrics. For example, the computing device 102 may sort the instances 108 in descending order, from largest to smallest size metric. At block 308, an initial state for the server assignment sequence or pattern may be established. In certain implementations, this initialization may involve setting up counters or pointers to track the current server 104 in an assignment sequence and potentially the current pass number if a multi-pass assignment pattern is used.

The method 300 may then enter an iterative process, starting with decision block 310, which checks if there are more instances 108 remaining to be assigned from the sorted list. If instances 108 remain (Yes path from block 310), the method proceeds to block 312, where the next instance 108 from the sorted list is selected. Subsequently, at block 314, a target server 104 is selected for the current instance 108 according to a defined assignment pattern logic. In certain implementations, the computing device 102 may execute logic to select the server 104 based on the current state initialized in block 308. For example, the logic may involve selecting the next server 104 in a predefined sequence during a first pass and selecting servers 104 in the reverse sequence during a subsequent pass (e.g., a zigzag pattern) to help balance load across servers 104.

Once the target server 104 is selected at block 314, the method 300 proceeds to block 316, where the selected instance 108 is assigned to the selected target server 104. In certain implementations, the computing device 102 may record this assignment, for instance, by updating the mapping 116. Following the assignment, at block 318, the state related to the assignment pattern may be updated. For example, the computing device 102 may advance a pointer to the next server 104 in the current sequence or increment a pass counter and potentially reverse the sequence direction if a pass through all available servers 104 is complete. After updating the state at block 318, the method 300 returns to decision block 310 to check if more instances 108 remain to be assigned. This loop continues until all instances 108 from the sorted list have been assigned. When decision block 310 determines that no more instances 108 are left to assign (No path from 310), the instance assignment method 300 may conclude.

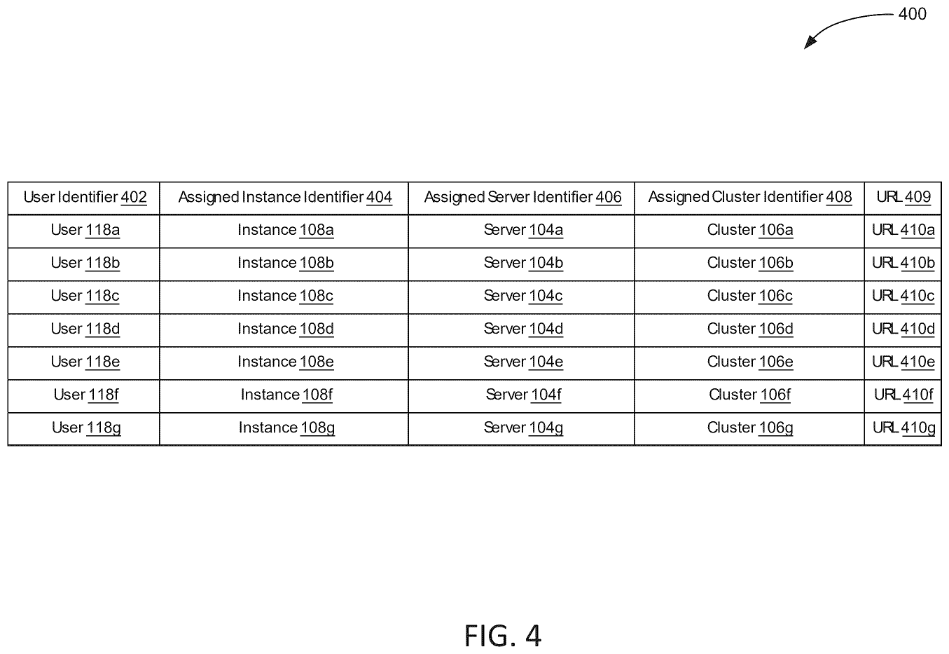

FIG. 4 illustrates a mapping 400 according to one aspect of the present disclosure. In certain implementations, the mapping data structure 400 may represent a possible implementation of the mapping 116 shown in FIG. 1. The mapping 400 may be organized, for example, as a table storing information linking users 118 to their assigned resources. In particular, the mapping 400 includes a user identifier column 402, an assigned instance identifier column 404 identifying the specific instance 108 allocated to the user 118, an assigned server identifier column 406 indicating the server 104 hosting that instance 108, an assigned cluster identifier column 408 specifying the cluster 106 containing the server 104, and a URL column 409 containing a specific URL (e.g., 410a-h) determined for routing the user computing device 112 to the correct instance 108 and server 104. For example, upon receiving a request from the user computing device 112 associated with user 118d, the first application 114 may consult the mapping 400, locate row 416 based on the user identifier 118d, and retrieve the corresponding URL 410d. The first application 114 may then route the user computing device 112 to the assigned instance 108c executing on server 104c within cluster 106b by directing the user computing device 112 to the retrieved URL 410d.

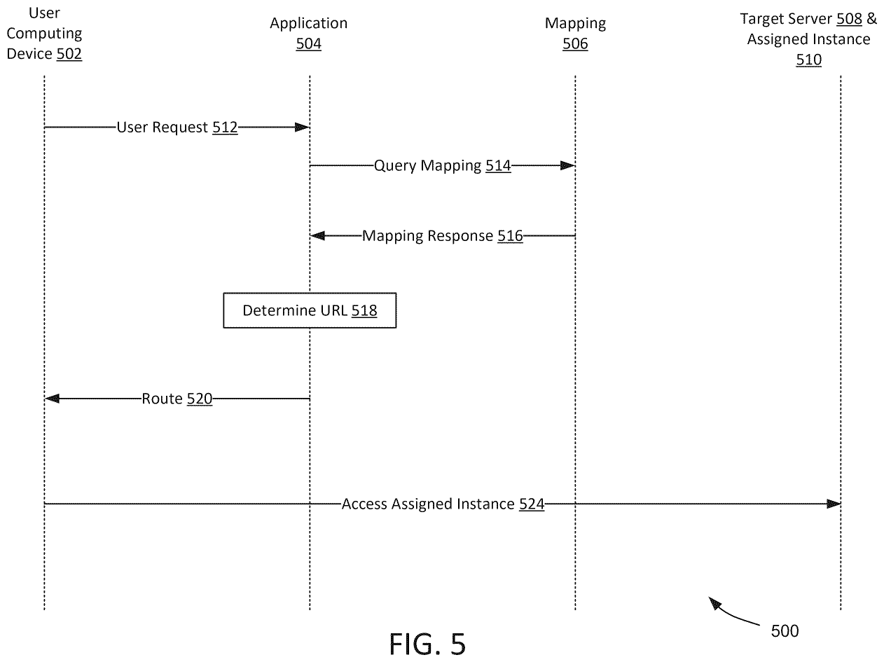

FIG. 5 illustrates a sequence diagram for a user request routing procedure 500 according to one aspect of the present disclosure. The procedure 500 includes interactions between various components when a user attempts to access their assigned distributed application instance. In certain implementations, the user request routing procedure 500 may be performed by the system 100 described in FIG. 1, involving components such as a user computing device 502, a first application 504 (which may be an exemplary implementation of the first application 114), a mapping 506 (which may be an exemplary implementation of the mapping 116), and a target server 508 hosting an assigned instance 510 (which may be an exemplary implementation of, e.g., the server 104a hosting instance 108a).

The user request routing procedure 500 may begin when the user computing device 502 sends an initial request 512 to the first application 504. In certain implementations, this request 512 may include information identifying the user, such as a user identifier corresponding to user 118a. Upon receiving the request 512, the first application 504 may query 514 the mapping 506, providing the user identifier extracted from the request 512.

The mapping 506 may process the query 514 and return a mapping response 516 to the first application 504. This response 516 may contain details about the assigned resources for the identified user 118a, such as the identifier for the assigned instance 108a and the identifier or address for the target server 104a hosting that instance 108a. Based on the information received in the response 516, the first application 504 may then to determine 518 the specific URL required to access the assigned instance 108a on the target server 104a and prepare for routing the user computing device 502.

Subsequently, the first application 504 may route or redirect 520 the user computing device 502, instructing the user computing device 502 to connect to the determined URL associated with the assigned instance 108a and target server 104a. Following the routing or redirection 520, the user computing device 502 may then initiate direct communication 524 to access the assigned instance 510 executing on the target server 508 using the provided URL.

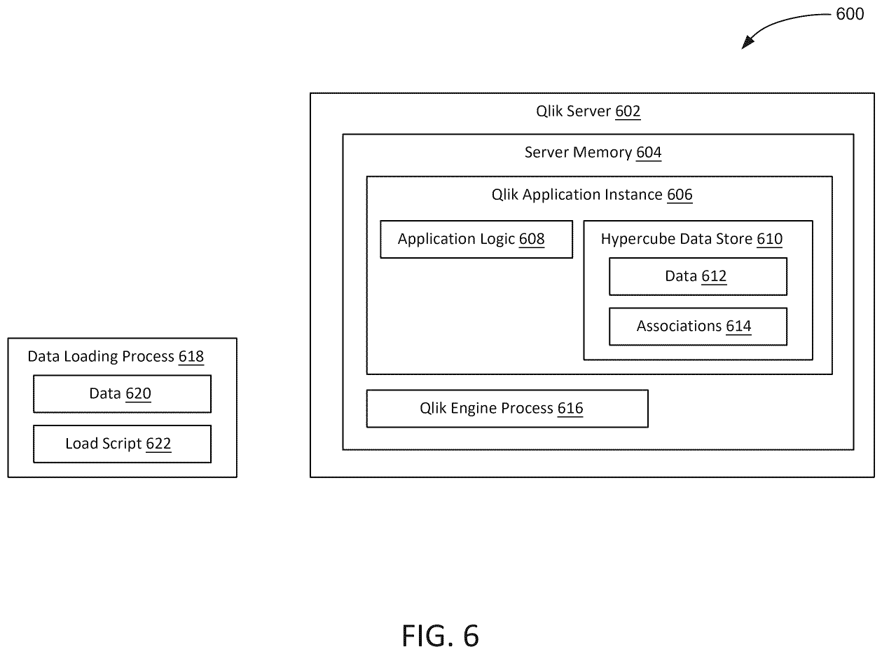

FIG. 6 illustrates a block diagram of a system 600 according to one aspect of the present disclosure. The system 600 provides a more specific view of how components described in relation to FIG. 1 may be realized using Qlik systems. The system 600 includes a Qlik server 602, which may represent a server such as server 104a within a Qlik cluster 106. Within the Qlik server 602, server memory 604 may be utilized to host one or more Qlik application instances 606, representing the operational units serving user requests.

Each Qlik application instance 606, corresponding to an instance 108 of the distributed application, may be loaded into the server memory 604 for execution. A Qlik application instance 606 typically includes an application logic/presentation layer 608. In certain implementations, the application logic/presentation layer 608 may be configured to handle user interface elements, define charts and visualizations, and manage the presentation of data to the user 118. The Qlik application instance 606 also includes a hypercube data store 610.

The hypercube data store 610 may serve as a specific implementation of the data store 110. In certain Qlik implementations, the hypercube data store 610 may be an in-memory data structure utilizing an associative model, containing loaded data 612. The loaded data 612 may reflect the combined data access requirements of the assigned user group 120, filtered and transformed from source systems. The hypercube data store 610 also includes the configured associations/model 614, which defines the relationships and links between different data fields and tables, enabling Qlik's associative filtering and analysis capabilities. The overall execution and management of the Qlik application instance 606, including calculations and responses to user interactions, may be handled by a Qlik engine process 616 running on the Qlik server 602.

The system 600 also illustrates a data loading process 618 responsible for populating the hypercube data store 610. This process may involve using a Qlik load script 622 to extract data from source data 620 (e.g., databases or files), perform necessary transformations (like joins, aggregations, or data cleansing), and load the resulting datasets into the hypercube data store 610 as loaded data 612. The Qlik load script 622 may also define the configured associations/model 614 during this process.

In certain implementations, the system 600 may be configured to perform one or more of the operations discussed previously, adapted to the specifics of the Qlik environment.

For example, the operation of initializing a data store 110 based on combined group requirements may be performed within the system 600 by the data loading process 618. In certain implementations, the computing device 102 may trigger the execution of the Qlik load script 622. This script 622 may connect to the appropriate source data 620, filter and extract the specific data required by the combined needs of the user group 120 assigned to the corresponding Qlik application instance 606, perform necessary data transformations, and load the final dataset into the server memory 604 as the loaded data 612 within the hypercube data store 610. The Qlik load script 622 may also simultaneously define the configured associations/model 614 within the hypercube data store 610, establishing the relationships between data fields necessary for associative analysis.

As another example, the operation of executing an assigned instance 108 may be performed within the system 600 by the Qlik engine process 616 running on the Qlik server 602. Once the Qlik application instance 606 and its corresponding hypercube data store 610 is loaded into server memory 604 (such as via preloading), the Qlik engine process 616 may actively manage the instance, keeping its data structures resident and ready for immediate query response. When a user interaction (e.g., a query, selection, or analysis request from a user 118 routed to this instance 606) is received, the Qlik engine process 616 utilizes the in-memory hypercube data store 610, leveraging the configured associations/model 614, to perform calculations rapidly. The results may then be used by the Qlik engine process 616 to update the application logic/presentation layer 608 for display to the user 118 via their user computing device 112.

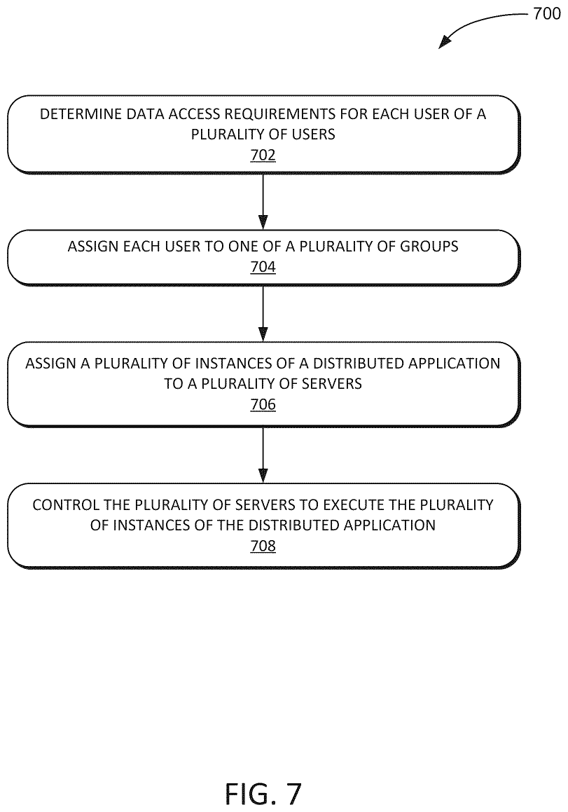

FIG. 7 depicts a method 700 for distributed application assignment and balancing according to one aspect of the present disclosure. The method 700 may be implemented on a computer system, such as the system 100. For example, the method 700 may be implemented by the computing device 102. The method 700 may also be implemented by a set of instructions stored on a computer readable medium that, when executed by a processor, cause the computing device to perform the method 700. Although the examples below are described with reference to the flowchart illustrated in FIG. 7, many other methods of performing the acts associated with FIG. 7 may be used. For example, the order of some of the blocks may be changed, certain blocks may be combined with other blocks, one or more of the blocks may be repeated, and some of the blocks may be optional.

At block 702, the method 700 may include determining data access requirements for each user of a plurality of users. For example, the computing system 102 may determine data access requirements for each user 118 of a plurality of users 118.

At block 704, the method 700 may include assigning each user to one of a plurality of groups. For example, the computing system 102 may assign each user 118 to one of a plurality of groups 120, wherein each group 120 includes users 118 with the same or similar data access requirements. In certain implementations, assigning each user 118 to one of the groups 120 may include selecting an initial user 118 with the largest data access requirement. The assignment process may then involve iteratively adding additional users 118 to the group 120. For each remaining user 118 not yet assigned to a group 120, this iterative addition may include determining a data overlap metric between the data access requirements of the remaining user 118 and the users 118 already in the group 120, and calculating an incremental increase in data size that would result from adding the remaining user 118 to the group 120. The remaining user 118 whose addition results in the smallest increase in total data size of the group's 120 data requirements may be selected. The selected user 118 may then be added to the group 120. This process of iteratively adding additional users 118 to the group 120 may continue until a predefined condition is satisfied. In certain implementations, the predefined condition may be satisfying at least one of: a maximum data size threshold for the group's 120 data requirements, a maximum number of users 118 assigned to the group 120, or a maximum total number of groups 120 formed.

At block 706, the method 700 may include assigning a plurality of instances of a distributed application to a plurality of servers. For example, the computing system 102 may assign a plurality of instances 108 of a distributed application to a plurality of servers 104, wherein each instance 108 of the distributed application corresponds to a respective group 120 of the plurality of groups 120 and provides access to data corresponding to the data access requirements of the users 118 in the respective group 120. In certain implementations, the plurality of servers 104 may be organized into a plurality of clusters 106, and assigning the plurality of instances 108 may include assigning instances 108 to servers 104 located in at least two different clusters 106 of the plurality of clusters 106. Furthermore, assigning the instances 108 to the plurality of servers 104 may include determining a size metric for each instance 108 based on the data requirements of the corresponding group 120. The instances 108 may then be sorted based on the determined size metrics. The method may proceed by iteratively assigning the sorted instances 108 to the plurality of servers 104. This iterative assignment may involve selecting an instance 108 based on the sorted order, selecting a target server 104 according to an assignment pattern, and assigning the selected instance 108 to the target server 104. In certain implementations, selecting the target server 104 according to the assignment pattern may include assigning instances 108 to servers 104 in a first sequence for a first pass through the sorted instances 108, and assigning instances 108 to servers 104 in a sequence that is the reverse of the first sequence for a subsequent pass through the sorted instances 108.

In certain implementations, each instance 108 of the distributed application may include a data store 110 including the data corresponding to the data access requirements of the users 118 in the respective group 120. The method 700 may further include initializing the data store 110 based on the combined data access requirements of the users 118 in the respective group 120. This initialization of the data store 110 may include loading into the data store 110 the data corresponding to the combined data access requirements of the users 118 in the group 120, and configuring the data store 110 to enable querying and analysis of the loaded data by the users 118 in the group 120. In specific implementations, the data store 110 may be implemented as a hypercube 610 in a Qlik application 606.

At block 708, the method 700 may include executing the plurality of instances of the distributed application by the plurality of servers. For example, the plurality of servers 104 may execute the plurality of instances 108 of the distributed application to which they were assigned. In certain implementations, the method 700 may further include preloading the instances 108 of the distributed application into memory 604 of the assigned servers 104, and maintaining the instances 108 in memory 604 by performing periodic interactions to prevent unloading due to inactivity.

The method 700 may further include determining, after assigning the plurality of instances 108 to the plurality of servers 104, a mapping 116, 400 of user identifiers 402 to their assigned instances 108 (e.g., referenced via an assigned instance identifier 404) of the distributed application and corresponding server 104 assignments (e.g., referenced via an assigned server identifier 406 and/or via an assigned cluster identifier 408).

Based on the determined mapping 116, 400, the method 700 may facilitate user access by performing routing operations. In certain implementations, the method 700 may include receiving, at a first application 114, a request 512 from a user computing device 112, 502. The first application 114, which may be a landing page application 504 configured to route user requests, may then determine, based on the mapping 116, 400, 506, an assigned instance 108, 510 of the distributed application and a corresponding server 104, 508 for the user 118 associated with the request 512. Subsequently, the first application 114, 504 may route 520 the user computing device 112, 502 to the assigned instance 108, 510 on the corresponding server 104, 508. This routing of the user computing device 112, 502 may include determining a URL 409 (e.g., 410a-h) based on the mapping 116, 400, 506 of the user's identifier 402 to the assigned instance 108, 404 and server 104, 406, and directing the user computing device 112, 502 to the determined URL. Furthermore, routing the user computing device 112, 502 may also include transmitting 522 authentication credentials or tokens associated with the user 118 to the assigned instance 108, 510 of the distributed application.

In certain implementations, the method 700 may also include periodically performing reassignments based on changing conditions. For example, the method 700 may include periodically reassigning users 118 to the plurality of groups 120, periodically reassigning the plurality of instances 108 of the distributed application to the plurality of servers 104, or a combination thereof, based on changes in user 118 data access requirements or other system conditions.

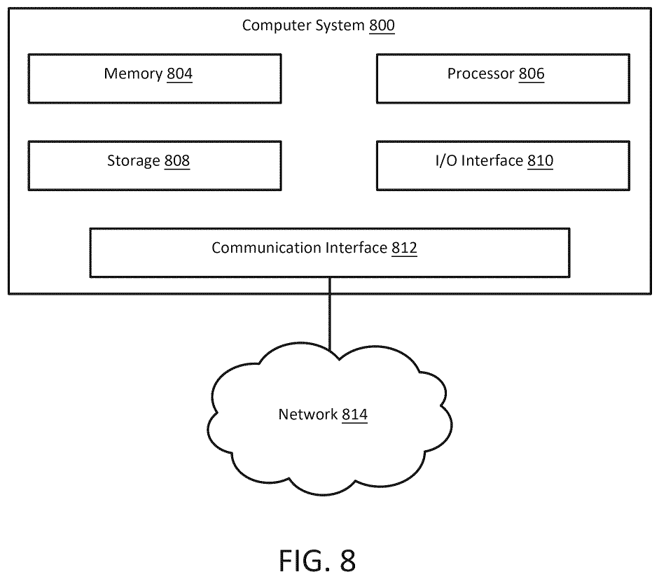

FIG. 8 illustrates an example computer system 800 that may be utilized to implement one or more of the devices and/or components discussed herein, such as the computing device 102, servers 104, user computing device 112, and components of the overall systems 100, 600. In particular embodiments, one or more computer systems 800 perform one or more steps of one or more methods described or illustrated herein, such as the user grouping method 200, the instance assignment method 300, the user request routing procedure 500, and/or the overall method 700. In particular embodiments, one or more computer systems 800 provide the functionalities described or illustrated herein, such as determining user requirements, assigning users 118 to groups 120, assigning instances 108 to servers 104 across clusters 106, initializing and executing instances 108 with their data stores 110 or hypercubes 610, maintaining the mapping 116, 400, and routing user requests via the first application 114. In particular embodiments, software running on one or more computer systems 800 performs one or more steps of one or more methods described or illustrated herein or provides the functionalities described or illustrated herein. Particular embodiments include one or more portions of one or more computer systems 800. Herein, a reference to a computer system may encompass a computing device, and vice versa, where appropriate. Moreover, a reference to a computer system may encompass one or more computer systems, where appropriate.

This disclosure contemplates any suitable number of computer systems 800. This disclosure contemplates the computer system 800 taking any suitable physical form. As example and not by way of limitation, the computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. For instance, servers 104 may be implemented as physical servers organized into clusters 106 within data centers or a cloud computing environment. The computing device 102 performing the grouping and assignment logic may also be implemented as one or more servers. Where appropriate, the computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time (e.g., routing user requests 500) or in batch mode (e.g., periodically performing the user grouping method 200 or instance assignment method 300) one or more steps of one or more methods described or illustrated herein. One or more computer systems 800 may perform at different times or at different locations one or more steps of one or more methods described or illustrated herein, where appropriate.

In particular embodiments, computer system 800 includes a processor 806, memory 804, storage 808, an input/output (I/O) interface 810, and a communication interface 812. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 806 includes hardware for executing instructions, such as those making up a computer program. As an example and not by way of limitation, to execute instructions, the processor 806 may retrieve (or fetch) the instructions from an internal register, an internal cache, memory 804, or storage 808; decode and execute the instructions; and then write one or more results to an internal register, internal cache, memory 804, or storage 808. For example, the processor 806 within computing device 102 may execute instructions to perform the user grouping method 200 and the instance assignment method 300. Processors 806 within servers 104 may execute instructions for the distributed application instances 108, including processing user interactions via engines like the Qlik engine process 616. Processors 806 within the system component hosting the first application 114 may execute instructions for handling incoming user requests 512, querying the mapping 506, and performing routing 520. In particular embodiments, the processor 806 may include one or more internal caches for data, instructions, or addresses. This disclosure contemplates the processor 806 including any suitable number of any suitable internal caches, where appropriate. As an example and not by way of limitation, the processor 806 may include one or more instruction caches, one or more data caches, and one or more translation lookaside buffers (TLBs). Instructions in the instruction caches may be copies of instructions in memory 804 or storage 808, and the instruction caches may speed up retrieval of those instructions by the processor 806. Data in the data caches may be copies of data in memory 804 or storage 808 that are to be operated on by computer instructions; the results of previous instructions executed by the processor 806 that are accessible to subsequent instructions or for writing to memory 804 or storage 808; or any other suitable data. The data caches may speed up read or write operations by the processor 806. The TLBs may speed up virtual-address translation for the processor 806. In particular embodiments, processor 806 may include one or more internal registers for data, instructions, or addresses. This disclosure contemplates the processor 806 including any suitable number of any suitable internal registers, where appropriate. Where appropriate, the processor 806 may include one or more arithmetic logic units (ALUs), be a multi-core processor, or include one or more processors 806. Although this disclosure describes and illustrates a particular processor, this disclosure contemplates any suitable processor.

In particular embodiments, the memory 804 includes main memory for storing instructions for the processor 806 to execute or data for processor 806 to operate on. As an example, and not by way of limitation, computer system 800 may load instructions from storage 808 or another source (such as another computer system 800) to the memory 804. The processor 806 may then load the instructions from the memory 804 to an internal register or internal cache. To execute the instructions, the processor 806 may retrieve the instructions from the internal register or internal cache and decode them. During or after execution of the instructions, the processor 806 may write one or more results (which may be intermediate or final results) to the internal register or internal cache. The processor 806 may then write one or more of those results to the memory 804. Memory 804 in servers 104 may be used for hosting the executing instances 108 and their associated in-memory data stores 110, such as Qlik hypercubes 610 containing loaded data 612. Memory 804 may allow instances 108 to be preloaded and maintained, and may support caching by application engines like the Qlik engine process 616. In particular embodiments, the processor 806 executes only instructions in one or more internal registers or internal caches or in memory 804 (as opposed to storage 808 or elsewhere) and operates only on data in one or more internal registers or internal caches or in memory 804 (as opposed to storage 808 or elsewhere). One or more memory buses (which may each include an address bus and a data bus) may couple the processor 806 to the memory 804. The bus may include one or more memory buses, as described in further detail below. In particular embodiments, one or more memory management units (MMUs) reside between the processor 806 and memory 804 and facilitate accesses to the memory 804 requested by the processor 806. In particular embodiments, the memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory implementations, this disclosure contemplates any suitable memory implementation.

In particular embodiments, the storage 808 includes mass storage for data or instructions. As an example and not by way of limitation, the storage 808 may include a hard disk drive (HDD), a floppy disk drive, flash memory, an optical disc, a magneto-optical disc, magnetic tape, or a Universal Serial Bus (USB) drive or a combination of two or more of these. The storage 808 may include removable or non-removable (or fixed) media, where appropriate. The storage 808 may be internal or external to computer system 800, where appropriate. Storage 808 may be used to store software for the distributed application instances 108, the first application 114, the mapping 116, 400, configuration data defining assignment patterns or size thresholds, user entitlement information, source data 620, and scripts like the Qlik load script 622. In particular embodiments, the storage 808 is non-volatile, solid-state memory. In particular embodiments, the storage 808 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 808 taking any suitable physical form. The storage 808 may include one or more storage control units facilitating communication between processor 806 and storage 808, where appropriate. Where appropriate, the storage 808 may include one or more storages 808. Although this disclosure describes and illustrates particular storage, this disclosure contemplates any suitable storage.

In particular embodiments, the I/O Interface 810 includes hardware, software, or both, providing one or more interfaces for communication between computer system 800 and one or more I/O devices. The computer system 800 may include one or more of these I/O devices, where appropriate. One or more of these I/O devices may enable communication between a person (i.e., a user 118) and computer system 800. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. User computing devices 112, 502 would utilize I/O devices to interact with the distributed application instances 108 via components like the application logic/presentation layer 608. An I/O device may include one or more sensors. Where appropriate, the I/O Interface 810 may include one or more device or software drivers enabling processor 806 to drive one or more of these I/O devices. The I/O interface 810 may include one or more I/O interfaces 810, where appropriate. Although this disclosure describes and illustrates a particular I/O interface, this disclosure contemplates any suitable I/O interface or combination of I/O interfaces.

In particular embodiments, communication interface 812 includes hardware, software, or both providing one or more interfaces for communication (such as, for example, packet-based communication) between computer system 800 and one or more other computer systems 800 or one or more networks 814. As an example and not by way of limitation, communication interface 812 may include a network interface controller (NIC) or network adapter for communicating with an Ethernet or any other wire-based network or a wireless NIC (WNIC) or wireless adapter for communicating with a wireless network, such as a Wi-Fi network. The communication interface 812 facilitates communication within the distributed system 100. For example, the communication interface 812 enables communication between the user computing device 112, 502 and the first application 114, 504, between the first application 504 and the mapping 506, between the user computing device 502 and the assigned instance 108, 510 on the target server 104, 508, between servers 104 within and across clusters 106, between the computing device 102 and servers 104, and for accessing external entitlement systems or source data 620. This disclosure contemplates any suitable network 814 and any suitable communication interface 812 for the network 814. As an example and not by way of limitation, the network 814 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 800 may include any suitable communication interface 812 for any of these networks, where appropriate. Communication interface 812 may include one or more communication interfaces 812, where appropriate. Although this disclosure describes and illustrates a particular communication interface implementations, this disclosure contemplates any suitable communication interface implementation.

The computer system 800 may also include a bus. The bus may include hardware, software, or both and may communicatively couple the components of the computer system 800 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. Such media may store instructions executable by processor 806 to perform the methods 200, 300, 500, 700 described herein, including the logic for the user grouping algorithm, the instance assignment algorithm, maintaining the mapping 116, 400, operating the first application 114 for routing, initializing data stores 110, and executing instances 108. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
determining, by a computing system, data access requirements for each user of a plurality of users;
assigning each user to one of a plurality of groups, wherein each group includes users with the same or similar data access requirements;
assigning a plurality of instances of a distributed application to a plurality of servers, wherein each instance of the distributed application corresponds to a respective group of the plurality of groups and provides access to data corresponding to the data access requirements of the users in the respective group; and
executing the plurality of instances of the distributed application by the plurality of servers.

2. The method of claim 1, wherein assigning each user to one of the groups comprises:
selecting an initial user with the largest data access requirement;
iteratively adding additional users to the group by:
for each remaining user not yet assigned to a group:
determining a data overlap metric between the data access requirements of the remaining user and the users already in the group; and
calculating an incremental increase in data size that would result from adding the remaining user to the group;
selecting the remaining user whose addition results in the smallest increase in total data size of the group's data requirements;
adding the selected user to the group; and
continuing to iteratively add additional users to the group until a predefined condition is satisfied.

3. The method of claim 2, wherein the predefined condition is satisfying at least one of: a maximum data size threshold for the group's data requirements, a maximum number of users assigned to the group, or a maximum total number of groups formed.

4. The method of claim 1, wherein each instance of the distributed application includes a data store comprising the data corresponding to the data access requirements of the users in the respective group, and further comprising:
initializing the data store based on the combined data access requirements of the users in the respective group.

5. The method of claim 4, wherein initializing the data store comprises:
loading into the data store the data corresponding to the combined data access requirements of the users in the group; and
configuring the data store to enable querying and analysis of the loaded data by the users in the group.

6. The method of claim 4, wherein the data store is implemented as a hypercube in a Qlik application.

7. The method of claim 1, further comprising periodically reassigning users to the plurality of groups, periodically reassigning the plurality of instances of the distributed application to the plurality of servers, or a combination thereof, based on changes in user data access requirements, changes in data volumes, or a combination thereof.

8. The method of claim 1, wherein the plurality of servers are organized into a plurality of clusters, and wherein assigning the plurality of instances comprises assigning instances to servers located in at least two different clusters of the plurality of clusters.

9. The method of claim 1, wherein assigning the instances to the plurality of servers further comprises:
determining a size metric for each instance based on the data requirements of the corresponding group;
sorting the instances based on the determined size metrics;
iteratively assigning the sorted instances to the plurality of servers by:
selecting an instance based on the sorted order;
selecting a target server according to an assignment pattern; and
assigning the selected instance to the target server.

10. The method of claim 9, wherein selecting the target server according to the assignment pattern comprises:
assigning instances to servers in a first sequence for a first pass through the sorted instances; and
assigning instances to servers in a sequence that is the reverse of the first sequence for a subsequent pass through the sorted instances.

11. The method of claim 1, further comprising:
determining, after assigning the plurality of instances to the plurality of servers, a mapping of user identifiers to their assigned instances of the distributed application and corresponding server assignments.

12. The method of claim 11, further comprising:
receiving, at a first application, a request from a user computing device;
determining, based on the mapping, an assigned instance of the distributed application and a corresponding server for the user associated with the request; and
routing, by the first application, the user computing device to the assigned instance on the corresponding server.

13. The method of claim 12, wherein the first application is a landing page application configured to route user requests.

14. The method of claim 12, wherein routing the user computing device comprises:
determining a URL based on the mapping of the user's identifier to the assigned instance and server; and
directing the user computing device to the determined URL.

15. The method of claim 12, wherein routing the user computing device further comprises:
transmitting authentication credentials or tokens associated with the user to the assigned instance of the distributed application.

16. The method of claim 1, further comprising:
preloading the instances of the distributed application into memory of the assigned servers; and
maintaining the instances in memory by performing periodic interactions to prevent unloading due to inactivity.

17. A system comprising:
a processor; and
a memory storing instructions which, when executed by the processor, cause the processor to perform operations including:
determining data access requirements for each user of a plurality of users;
assigning each user to one of a plurality of groups, wherein each group includes users with the same or similar data access requirements;
assigning a plurality of instances of a distributed application to a plurality of servers, wherein each instance of the distributed application corresponds to a respective group of the plurality of groups and provides access to data corresponding to the data access requirements of the users in the respective group; and
controlling the plurality of servers to execute the plurality of instances of the distributed application.

18. The system of claim 17, wherein assigning each user to one of the groups comprises:
selecting an initial user with the largest data access requirement;
iteratively adding additional users to the group by:
for each remaining user not yet assigned to a group:
determining a data overlap metric between the data access requirements of the remaining user and the users already in the group; and
calculating an incremental increase in data size that would result from adding the remaining user to the group;
selecting the remaining user whose addition results in the smallest increase in total data size of the group's data requirements;
adding the selected user to the group; and
continuing to iteratively add additional users to the group until a predefined condition is satisfied.

19. The system of claim 17, wherein the plurality of servers are organized into a plurality of clusters, and wherein assigning the plurality of instances comprises assigning instances to servers located in at least two different clusters of the plurality of clusters.

20. A non-transitory, computer-readable medium storing instructions which, when executed by a processor, cause the processor to perform operations, comprising:
determining data access requirements for each user of a plurality of users;
assigning each user to one of a plurality of groups, wherein each group includes users with the same or similar data access requirements;
assigning a plurality of instances of a distributed application to a plurality of servers, wherein each instance of the distributed application corresponds to a respective group of the plurality of groups and provides access to data corresponding to the data access requirements of the users in the respective group; and
controlling the plurality of servers to execute the plurality of instances of the distributed application.
